(19) United States
(12) Patent Application Publication
(10) Pub. No.: US 2021/0405739 A1
(43) Pub. Date: Dec. 30, 2021

(54) MOTION MATCHING FOR VR FULL BODY RECONSTRUCTION

(71) Applicant: Sony Interactive Entertainment Inc., Tokyo (JP)

(72) Inventor: Sergey Bashkirov, San Mateo, CA (US)

(21) Appl. No.: 16/913,079

(22) Filed: Jun. 26, 2020

(51) Int. Cl. G06F 3/01; G06T 13/40; G02B 27/01

(52) U.S. Cl. CPC G06F 3/012; G02B 27/0172; G06T 13/40; G06F 3/017

(57) ABSTRACT

Motion sensor assemblies are provided on the head and in both hands of a person to generate pose information. The pose information is used to enter a database of animations of whole skeleton bone poses that correlates signals from the three assemblies to whole body pose signals. The closest matching frame in the database and subsequent frames are used to provide a whole-body animation sequence based on the signals from the three motion sensor assemblies.

### FIELD

The application relates to technically inventive, non-routine solutions that are necessarily rooted in computer technology and that produce concrete technical improvements.

### BACKGROUND

Knowing the “pose” (location and orientation) of various objects can be useful in many computer applications. As but one example, computer games such as virtual reality (VR) or augmented reality (AR) games are sometimes designed to receive, as input, pose information from a VR/AR headset worn by a player, or pose information of a hand-held device such as a computer game handset.

Current positioning solutions sometimes rely on visual tracking of objects with a video camera or laser beam to track the pose of objects of interest. These technologies require a sensor device to be within line of sight of the object for light to be able to travel towards device without meeting obstacles. Most solutions require a considerable number of body parts to be tracked simultaneously in order to reconstruct the full body pose. This requires a person to have additional tracking devices or markers to be attached to his/her body parts besides of the headset and controllers.

### SUMMARY

Present principles are directed to minimizing the tracking devices needed by using only components a person typically has for gaming, in other words, to reconstruct realistic-looking entire body animation for virtual characters representing real people wearing a virtual reality (VR) headset and holding two controllers in hands. Poses and velocities of a few body parts are obtained and used to reconstruct the most suitable animation sequence for all body parts. In this way entire human body pose over time can be reconstructed given information coming from a VR headset and the hand-held controllers. It can be used for visualizing human pose in multiplayer games or social software.

Accordingly, in a first aspect a method includes engaging N motion sensor assemblies (MSA) to respective N body parts. In an example embodiment, N=3. The MSA output pose information related to the respective body parts, wherein N is an integer. The method includes identifying in at least one dataset a frame of an animation sequence most closely matching the pose information. Each frame in the animation sequence includes skeletal pose information of >N bones. The method includes playing the animation sequence, in example embodiments beginning with the closest frame.

In some implementations the frame is a first frame, the animation sequence is a first animation sequence, the pose information is first pose information, and the method includes, during play of the first animation sequence, identifying a second frame in the dataset. The method includes, responsive to the second frame in the dataset more closely matching current pose information from the MSA than the first frame matched the first pose information, switching to playing a second animation sequence associated with the second frame, if desired starting with the second frame.

In some implementations the method may include switching to playing the second animation sequence responsive to determining a threshold improvement is provided thereby, and otherwise not switching to playing the second animation sequence.

In example embodiments, each of at least some frames in the dataset includes all virtual skeleton bone poses correlated with a sequence of three bone poses and velocities over K−1 frames preceding a current frame and the current frame itself. Each of at least some frames in the dataset may further include a total of 3×K pose-velocity pairs.

In another aspect, an assembly includes plural motion sensor assemblies (MSA) outputting pose information related to poses of plural respective real-world body parts. The assembly also includes at least one transmitter sending the pose information to at least one processor configured with instructions to receive the pose information, use the pose information to identify in at least one dataset an animation sequence of more body parts than the plural respective real-world body parts, and play the animation sequence.

In another aspect, an apparatus includes at least one processor programmed with instructions to receive pose information generated by a head-wearable motion sensor assembly and two hand-holdable motion sensor assemblies. The instructions are executable to correlate the pose information to animation sequence including animations of moving bones in addition to skull and hands.

The details of the present application, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example system including an example in accordance with present principles;

FIG. 2 is a block diagram of example pose-sensing components of an example motion sensing assembly;

FIG. 3 illustrates a person with three motion sensor assemblies, one on the head and one in each hand;

FIG. 4 illustrates sequences of animation frames and their corresponding data; and

FIGS. 5 and 6 illustrate example logic in example flow chart format.

### DETAILED DESCRIPTION

This disclosure relates generally to computer ecosystems including aspects of consumer electronics (CE) device networks such as but not limited to computer game networks. A system herein may include server and client components, connected over a network such that data may be exchanged between the client and server components. The client components may include one or more computing devices including game consoles such as Sony PlayStation® or a game console made by Microsoft or Nintendo or other manufacturer virtual reality (VR) headsets, augmented reality (AR) headsets, portable televisions (e.g. smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple Computer or Google. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may include one or more processors executing instructions that configure the servers to receive and transmit data over a network such as the Internet. Or, a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website to network members.

As used herein, instructions refer to computer-implemented steps for processing information in the system. Instructions can be implemented in software, firmware or hardware and include any type of programmed step undertaken by components of the system.

A processor may be a single- or multi-chip processor that can execute logic by means of various lines such as address lines, data lines, and control lines and registers and shift registers.

Software modules described by way of the flow charts and user interfaces herein can include various sub-routines, procedures, etc. Without limiting the disclosure, logic stated to be executed by a particular module can be redistributed to other software modules and/or combined together in a single module and/or made available in a shareable library.

Present principles described herein can be implemented as hardware, software, firmware, or combinations thereof; hence, illustrative components, blocks, modules, circuits, and steps are set forth in terms of their functionality.

Further to what has been alluded to above, logical blocks, modules, and circuits described below can be implemented or performed with a processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

The functions and methods described below, when implemented in software, can be written in an appropriate language such as but not limited to Java, C# or C++, and can be stored on or transmitted through a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires. Such connections may include wireless communication connections including infrared and radio.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

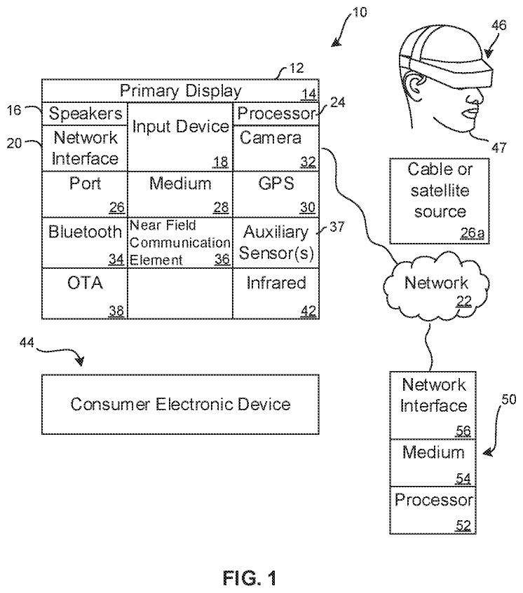

Now specifically referring to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to an Internet-enabled TV with a TV tuner (equivalently, set top box controlling a TV). However, the AVD 12 alternatively may be an appliance or household item, e.g. computerized Internet enabled refrigerator, washer, or dryer. The AVD 12 alternatively may also be a computerized Internet enabled (“smart”) telephone, a tablet computer, a notebook computer, a wearable computerized device such as e.g. computerized Internet-enabled watch, a computerized Internet-enabled bracelet, other computerized Internet-enabled devices, a computerized Internet-enabled music player, computerized Internet-enabled head phones, a computerized Internet-enabled implantable device such as an implantable skin device, etc. Regardless, it is to be understood that the AVD 12 is configured to undertake present principles (e.g. communicate with other CE devices to undertake present principles, execute the logic described herein, and perform any other functions and/or operations described herein).

Accordingly, to undertake such principles the AVD 12 can be established by some or all of the components shown in FIG. 1. For example, the AVD 12 can include one or more displays 14 that may be implemented by a high definition or ultra-high definition “4K” or higher flat screen and that may be touch-enabled for receiving user input signals via touches on the display. The AVD 12 may include one or more speakers 16 for outputting audio in accordance with present principles, and at least one additional input device 18 such as e.g. an audio receiver/microphone for e.g. entering audible commands to the AVD 12 to control the AVD 12. The example AVD 12 may also include one or more network interfaces 20 for communication over at least one network 22 such as the Internet, an WAN, an LAN, etc. under control of one or more processors 24 including. A graphics processor 24A may also be included. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as e.g. controlling the display 14 to present images thereon and receiving input therefrom. Furthermore, note the network interface 20 may be, e.g., a wired or wireless modem or router, or other appropriate interface such as, e.g., a wireless telephony transceiver, or Wi-Fi transceiver as mentioned above, etc.

In addition to the foregoing, the AVD 12 may also include one or more input ports 26 such as, e.g., a high definition multimedia interface (HDMI) port or a USB port to physically connect (e.g. using a wired connection) to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be, e.g., a separate or integrated set top box, or a satellite receiver. Or, the source 26a may be a game console or disk player containing content that might be regarded by a user as a favorite for channel assignation purposes described further below. The source 26a when implemented as a game console may include some or all of the components described below in relation to the CE device 44.

The AVD 12 may further include one or more computer memories 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media. Also in some embodiments, the AVD 12 can include a position or location receiver such as but not limited to a cellphone receiver, GPS receiver and/or altimeter 30 that is configured to e.g. receive geographic position information from at least one satellite or cellphone tower and provide the information to the processor 24 and/or determine an altitude at which the AVD 12 is disposed in conjunction with the processor 24. However, it is to be understood that another suitable position receiver other than a cellphone receiver, GPS receiver and/or altimeter may be used in accordance with present principles to e.g. determine the location of the AVD 12 in e.g. all three dimensions.

Continuing the description of the AVD 12, in some embodiments the AVD 12 may include one or more cameras 32 that may be, e.g., a thermal imaging camera, a digital camera such as a webcam, and/or a camera integrated into the AVD 12 and controllable by the processor 24 to gather pictures/images and/or video in accordance with present principles. Also included on the AVD 12 may be a Bluetooth transceiver 34 and other Near Field Communication (NFC) element 36 for communication with other devices using Bluetooth and/or NFC technology, respectively. An example NFC element can be a radio frequency identification (RFID) element. Zigbee also may be used.

Further still, the AVD 12 may include one or more auxiliary sensors 37 (e.g., a motion sensor such as an accelerometer, gyroscope, cyclometer, or a magnetic sensor, an infrared (IR) sensor, an optical sensor, a speed and/or cadence sensor, a gesture sensor (e.g. for sensing gesture command), etc.) providing input to the processor 24. The AVD 12 may include an over-the-air TV broadcast port 38 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12.

Still referring to FIG. 1, in addition to the AVD 12, the system 10 may include one or more other CE device types. In one example, a first CE device 44 may be used to send computer game audio and video to the AVD 12 via commands sent directly to the AVD 12 and/or through the below-described server while a second CE device 46 may include similar components as the first CE device 44. In the example shown, the second CE device 46 may be configured as a VR headset worn by a player 47 as shown, or a hand-held game controller manipulated by the player 47. In the example shown, only two CE devices 44, 46 are shown, it being understood that fewer or greater devices may be used.

In the example shown, to illustrate present principles all three devices 12, 44, 46 are assumed to be members of an entertainment network in, e.g., a home, or at least to be present in proximity to each other in a location such as a house. However, present principles are not limited to a particular location unless explicitly claimed otherwise.

The example non-limiting first CE device 44 may be established by any one of the above-mentioned devices, for example, a portable wireless laptop computer or notebook computer or game controller (also referred to as “console”), and accordingly may have one or more of the components described in relation to the AVD 12 and/or discussed further below. The second CE device 46 may include some or all of the components shown for the CE device 44. Either one or both CE devices may be powered by one or more batteries.

Now in reference to the afore-mentioned at least one server 50, it includes at least one server processor 52, at least one tangible computer readable storage medium 54 such as disk-based or solid-state storage, and at least one network interface 56 that, under control of the server processor 52, allows for communication with the other devices of FIG. 1 over the network 22, and indeed may facilitate communication between servers and client devices in accordance with present principles. Note that the network interface 56 may be, e.g., a wired or wireless modem or router, Wi-Fi transceiver, or other appropriate interface such as, e.g., a wireless telephony transceiver.

Accordingly, in some embodiments the server 50 may be an Internet server or an entire server “farm”, and may include and perform “cloud” functions such that the devices of the system 10 may access a “cloud” environment via the server 50 in example embodiments for, e.g., network gaming applications. Or, the server 50 may be implemented by one or more game consoles or other computers in the same room as the other devices shown in FIG. 1 or nearby.

The methods herein may be implemented as software instructions executed by a processor, suitably configured Advanced RISC Machine (ARM) microcontroller, an application specific integrated circuits (ASIC) or field programmable gate array (FPGA) modules, or any other convenient manner as would be appreciated by those skilled in those art. For example, a real-time operating system (RTOS) microcontroller may be used in conjunction with Linus or Windows-based computers via USB layers. Where employed, the software instructions may be embodied in a non-transitory device such as a CD ROM or Flash drive. The software code instructions may alternatively be embodied in a transitory arrangement such as a radio or optical signal, or via a download over the internet.

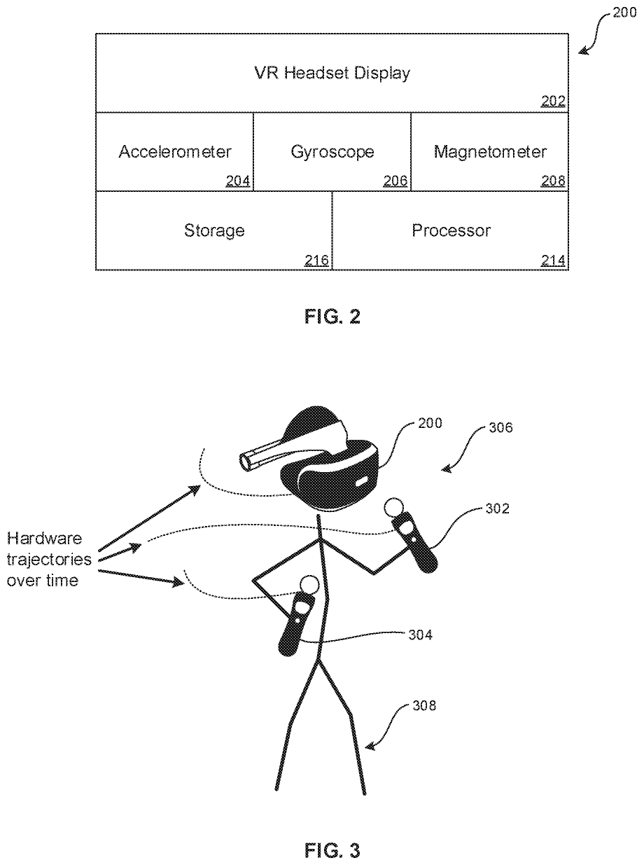

FIG. 2 shows an example assembly 200 that may be incorporated into an object such as but not limited the object 47 in FIG. 1, e.g., a VR/AR headset or a hand-held computer game controller, to determine pose information related to the object and to send that pose information to, e.g., a computer game as input to the game. “Pose information” typically can include location in space and orientation in space.

The assembly 200 may include a headset display 202 for presenting demanded images, e.g., computer game images. The assembly 200 may also include an accelerometer 204 with three sub-units, one each for determining acceleration in the x, y, and z axes in Cartesian coordinates. A gyroscope 206 may also be included to, e.g., detect changes in orientation over time to track all three rotational degrees of freedom. While the assembly 200 may exclude the accelerometer 204 (and/or gyroscope 206) and rely only on a magnetometer 208, the accelerometer 204 (and/or gyroscope 206) may be retained as it is very fast compared to the magnetometer. Or, the magnetometer may be excluded. No magnet need be used in the assembly 200. All three of the accelerometer, gyroscope, and magnetometer may be included to provide a 9-axis of motion sensor.

A processor 214 accessing instructions on a computer memory 216 may receive signals from the magnetometer 208, accelerometer 204, and gyroscope 206 and may control the display 202 or feed pose data to different consumers, e.g., partner gamers. The processor 214 may execute the logic below to determine aspects of pose information using the signals from the sensors shown in FIG. 2 and may also communicate with another computer such as but not limited to a computer game console using any of the wired or wireless transceivers shown in FIG. 1 and described above, including communication of the pose information to the other computer. In some embodiments the data from the magnetometer may be uploaded to a remote processor that executes the logic below.

Moving to FIG. 3, three hardware pieces are shown to trace their trajectories in space as pose over time. Pose represents position and orientation of a hardware piece. In the example, the three pieces include a head-mounted motion sensor assembly such as the assembly 200 shown in FIG. 2 and left and right hand-held motion sensor assemblies 302, 304 that may include any of the motion sensors illustrated in FIG. 2. As another example, the motion sensor assemblies may be implemented by the event driven sensor (EDS) systems described in the present inventor's co-pending U.S. patent application Ser. No. 16/741,051, incorporated herein by reference. The hardware pieces are mounted on or attached to a body 306 with many bones 308 (such as leg bones) that exceed the number of hardware pieces.

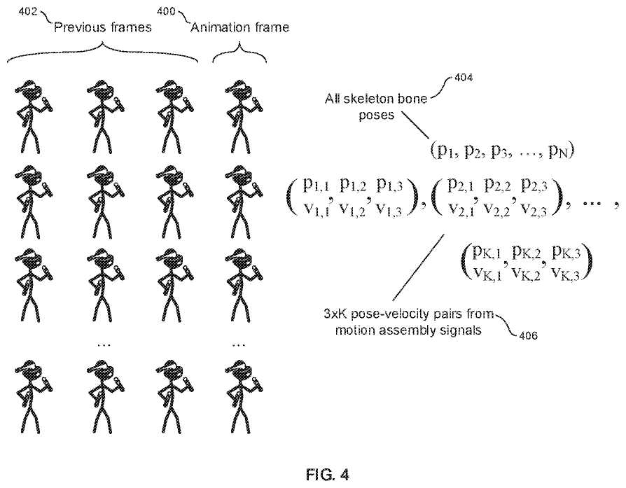

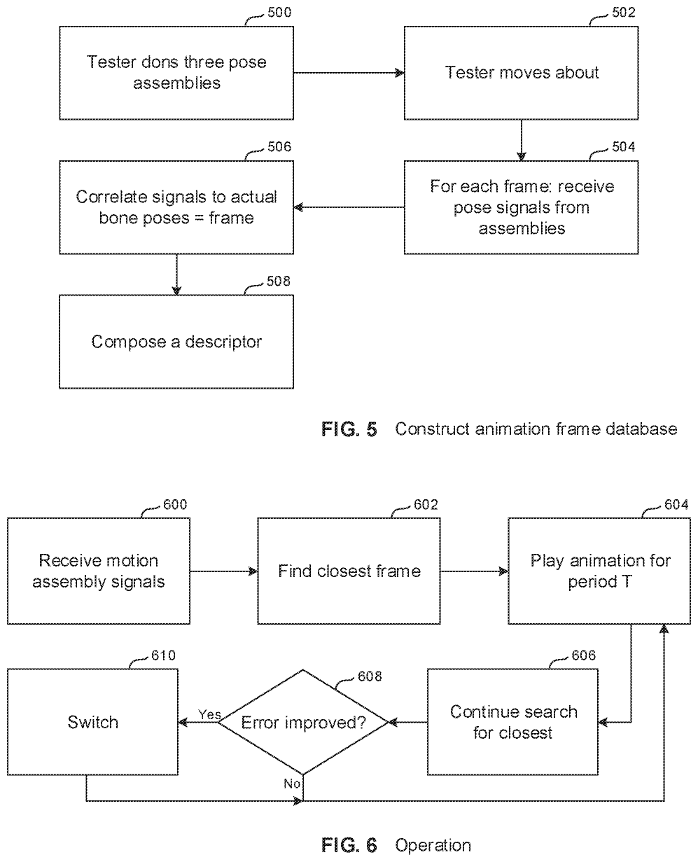

FIGS. 4 and 5 illustrate generation of a preliminary collected animations dataset that produces sequences of animation frames 400 each of which may be associated with K−1 previous frames 402. Note that in FIG. 4, the number of hardware pieces (the number of motion sensor assemblies) is three, as shown in FIG. 3. This is by way of example. Note further that the “N” used in FIG. 4 refers to the number of bones, not the number of hardware pieces.

To generate the dataset, as indicated at block 500 in FIG. 5 a tester dons the motion assemblies shown in FIG. 3 and then at block 502 performs various semi-random movements continuously for some time, e.g., ten to twenty minutes. As the tester moves, for each frame the pose signals from the motion sensor assemblies are received at block 504 and correlated at block 506 to all skeleton bone poses as imaged by, e.g., one or more cameras or EDS or combinations thereof. A descriptor as described further herein is composed at block 508. This provides a number of reasonable poses and transitions the human body can have.

The animations collection consists of individual animation frames. Each animation frame consists of poses of individual virtual skeleton bones.

This is illustrated further in FIG. 4. As shown at 404, an animation frame includes all virtual skeleton bone poses (including leg bone poses) correlated with a sequence of three bone poses (in the example herein, the skull and two hands) and velocities over K−1 frames preceding current frame and current frame itself, as shown at 406, for a total of 3×K pose-velocity pairs, which is referred to herein as a frame descriptor. Note that more generally, when N motion sensor assemblies are used, there would be a total of NxK pose-velocity pairs.

The sequence of three bone poses and velocities over K−1 frames preceding current frame and current frame itself are derived from the signals of the motion sensor assemblies as the tester moves about in block 502 of FIG. 5. In other words, given the signals from the headset and two hand-held controllers representing poses and velocities over time, an appropriate frame descriptor is composed.

Subsequently, once the dataset has been generated, FIG. 6 illustrates that during operation signals from the motion sensor assemblies received at block 600 are used to compose frame descriptors, which are used at block 602 to search for the closest animation frame in the animation dataset on the basis of having the frame descriptor most closely matching that of the current signals. An example matching criteria may be to select, as the closest frame in the dataset, the frame whose frame descriptor has the smallest Euclidean distance to the current frame descriptor than other frames. This can be thought of as a “descriptor difference”.

Incidentally, in detailed examples, prior to computing distances all quantities may be scaled to be in comparable units. This may be done by normalizing each coordinate by its standard deviation (or amplitude) within the range of numbers in the dataset.

From block 602 the logic flows to block 604 to play an animation for a predefined period T starting with the closest frame just found at block 602. Proceeding to block 606, as the animation plays and the person moving the motion assemblies continues to move (generating updated signals from the motion sensor assemblies), the search for the closest animation frame in the animation dataset to the current data from the motion sensors assemblies continues as the animation is played. The closest frame in the dataset to the most recently received pose signals from the motion sensor assemblies is identified and compared, using the descriptor distance described above, to the descriptor distance of the closest animation frame from block 602.

Moving to decision diamond 608, it is determined whether switching to playing animation from the frame identified at block 606 would improve the error between the current motion signals and the closest matching frame in the dataset by at least a predefined constant threshold amount. In an example this is done by determining whether the descriptor distance determined at block 606 is smaller than the descriptor distance determined at block 602. Animation is switched at block 610 to begin at the frame identified at block 606 if the switch improves the error by, e.g., a threshold amount. On the other hand, if switching would not improve the error by the threshold amount, animation continues using the sequence that began with the frame identified at block 602, with the logic looping back to block 604 in either case to play whichever animation sequence resulted from the test at decision diamond 608.

It may now be appreciated that given the poses as indicated by the respective signals from three hardware pieces, a subset of animation frames in the dataset is identified for which appropriate bone poses match hardware piece poses. As further understood herein, to shrink down possible matches the number of search constraints may be increased by using the current frame and a few previous frames staying some delta t apart.

In example embodiments, post processing may come into play. More specifically, because an animation switch to a new “closest” frame can produces an animation “jump”, one or more techniques may be employed to smooth out the “jump”. As one example, the animation output may be low pass filtered. As another example, the displayed animation character can be modeled by physically simulated rigid bodies connected to animation bones by means of springs with some damping. Because a rigid body cannot change its position instantly, this provides naturally looking smoothing. Yet again, physics-based animation of a body consisting of physically simulated rigid bodies driven by a neural network can be used with the goal to follow target animation coming from the algorithm.

It will be appreciated that whilst present principals have been described with reference to some example embodiments, these are not intended to be limiting, and that various alternative arrangements may be used to implement the subject matter claimed herein.

1. A method comprising:
engaging no more than N motion sensor assemblies (MSA) to respective N body parts, the MSA outputting pose information related to the respective body parts;
identifying, using at least one computer processor, in at least one dataset established prior to the MSA outputting the pose information, a frame of an animation sequence based on the frame most closely matching the pose information, each frame in the animation sequence comprising skeletal pose information of >N bones; and
playing the animation sequence on at least one display.

2. The method of claim 1, comprising playing the animation sequence beginning with the closest frame.

3. The method of claim 1, wherein the frame is a first frame, the animation sequence is a first animation sequence, the pose information is first pose information, and the method comprises:
during play of the first animation sequence, identifying a second frame in the dataset; and
responsive to the second frame in the dataset more closely matching current pose information from the MSA than the first frame matched the first pose information, switching to playing a second animation sequence associated with the second frame.

4. The method of claim 3, comprising playing the second animation sequence starting with the second frame.

5. The method of claim 3, comprising switching to playing the second animation sequence responsive to determining a threshold improvement is provided thereby, and otherwise not switching to playing the second animation sequence.

6. The method of claim 1, wherein each of at least some frames in the dataset comprises:
all virtual skeleton bone poses correlated with a sequence of three bone poses and velocities over K−1 frames preceding a current frame and the current frame itself.

7. The method of claim 6, wherein each of at least some frames in the dataset further comprises a total of 3×K pose-velocity pairs.

8. An assembly comprising:
plural motion sensor assemblies (MSA) outputting pose information related to poses of plural respective real-world body parts;
at least one transmitter sending the pose information to at least one processor configured with instructions to:
receive the pose information;
use the pose information to identify in at least one dataset an animation sequence of more body parts than the plural respective real-world body parts; and
play the animation sequence.

9. The assembly of claim 8, wherein the instructions are executable to:
play the animation sequence beginning with a closest frame to the pose information.

10. The assembly of claim 9, wherein the closest frame is a first frame, the animation sequence is a first animation sequence, the pose information is first pose information, and the instructions are executable to:
during play of the first animation sequence, identify a second frame in the dataset; and
responsive to the second frame in the dataset more closely matching current pose information than the first frame matched the first pose information, switch to playing a second animation sequence associated with the second frame.

11. The assembly of claim 10, wherein the instructions are executable to play the second animation sequence starting with the second frame.

12. The assembly of claim 10, wherein the instructions are executable to switch to playing the second animation sequence responsive to determining a threshold improvement is provided thereby, and otherwise not switch to playing the second animation sequence.

13. The assembly of claim 8, wherein each of at least some frames in the dataset comprise:
all virtual skeleton bone poses correlated with a sequence of three bone poses and velocities over K−1 frames preceding a current frame and the current frame itself.

14. The assembly of claim 13, wherein each of at least some frames in the dataset further comprise a total of 3×K pose-velocity pairs.

15. An apparatus comprising:
at least one processor programmed with instructions to:
receive pose information generated by a head-wearable motion sensor assembly and two hand-holdable motion sensor assemblies; and
correlate the pose information to animation sequence comprising animations of moving bones in addition to skull and hands.

16. The apparatus of claim 15, wherein the instructions are executable to:
play the animation sequence beginning with a closest frame to the pose information.

17. The apparatus of claim 16, wherein the closest frame is a first frame, the animation sequence is a first animation sequence, the pose information is first pose information, and the instructions are executable to:
during play of the first animation sequence, identify a second frame in a dataset; and
responsive to the second frame in the dataset more closely matching current pose information than the first frame matched the first pose information, switch to playing a second animation sequence associated with the second frame.

18. The apparatus of claim 17, wherein the instructions are executable to play the second animation sequence starting with the second frame.

19. The apparatus of claim 17, wherein the instructions are executable to switch to playing the second animation sequence responsive to determining a threshold improvement is provided thereby, and otherwise not switch to playing the second animation sequence.

20. The apparatus of claim 15, wherein each of at least some frames in the animation sequence comprise:
all virtual skeleton bone poses correlated with a sequence of three bone poses and velocities over K−1 frames preceding a current frame and the current frame itself.
